(19) United States
(12) Patent Application Publication
(10) Pub. No.: US 2007/0033586 A1
(43) Pub. Date: Feb. 8, 2007

(54) Method for blocking the installation of a patch

(75) Inventors: Praveen Prasanna Kumar Hirsave, Austin, TX (US); Edmund Troche, Austin, TX (US); Minto Tsai, Austin, TX (US); Patrick Leo Woods, Pflugerville, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/195,024

(22) Filed: Aug. 2, 2005

(51) Int. Cl. G06F 9/445

(52) U.S. Cl. 717/174

(57) ABSTRACT

A method, apparatus and computer instructions are provided for blocking the installation of a patch. A patch management system is used to recognize files with a selected indicator. A selected indicator may be an identifier distinguishing the file such as size, checksum, name, or a current timestamp. The files with a selected indicator contain signatures that may be cross referenced with patch metadata. The signature of the patch file is validated against policies that indicate the patch has been approved for installation. If the patch is approved the files are installed. In response to a patch being unapproved for installation a locking mechanism locks files targeted by patches based on patch metadata, patch content, and/or patch instructions so that the patch may not be installed.

### BACKGROUND OF THE INVENTION

1. Technical Field

The present invention relates to the installation of files. Particularly, the present invention provides a method for blocking the installation of a patch.

2. Description of Related Art

Patches are fixes to software code. If a user experiences problems with particular software, the user may contact the vendor of the software for a patch that is applicable to the software. Patches are usually directed to fix particular problem or symptom in software that matches a user's software experienced problem or symptom. Often a patch is first tested in a test environment to validate that the patch does indeed fix the problem. In general, a very successful attitude about patches with regard to software products has been, “If a user does not experience a problem, do not apply the patch. Wait for a maintenance release to catch the user up.” This attitude still applies today.

With the advent of the three-tier architecture, a different approach is advocated with patches that impact the most rapidly changing (and sometimes more temperamental) areas of software management. The general recommendation is to install the very latest patches for particular sections of code. Every attempt is usually made to validate testing of patches against all software releases that require testing. However, since the software code is highly extensible and the tasks to which the software code can be subjected are widely diverse, there may be defects in patches that relate to the use of the code in some highly specific manner or under a specific set of (perhaps not reproducible or unforeseen) environmental conditions. Usually, it is not the intent of software vendors to mass-produce single-fix patches.

Software patches may take several forms:
E-fix (an emergency fix created to alleviate an urgent issue specifically at your site)
Limited availability patch
General availability patch.

E-fixes are emergency fixes meant to be deployed only to a single user. E-fixes are not intended to be obtained from other software users and applied in a different environment. The deployment of an e-fix is generally part of a high level of user support being provided in extenuating circumstances. This above average support is reserved for such critical situations, and is therefore not generally available to all users. E-fixes are usually customized for a specific user's environment, and therefore will not typically be the same exact fix as what will be available in a subsequent patch once released. Therefore, there can be serious repercussions for users who apply e-fixes not intended for their environment. It is important to understand that e-fixes are NOT well tested. Users are often asked to sign a waiver in order to download the patch and apply it to their environment.

Limited availability (LA) patches are a limited release of a patch just prior to general availability. The interp type that the LA patch is written for will be the same as the general availability code. ALL OTHER interp types are completely untested at this stage and should NOT be implemented. General availability (GA) patches are patches intended to be distributed to all users. These patches have completed the validation process.

Usually, as new patches are produced, the software vendor communicates that a patch has been released in various ways, including:
The mailing of notices to internal resources. This notification alerts support, account management teams worldwide, service professionals, and the single points of contact worldwide.
The posting of notices on an external Web site.
An e-mail push notification when patches become available. The e-mail push is generated from the Customer Support News Web-based support tool.

Patches usually have prerequisite conditions for installing the patch including, but not limited to:
The base product that the patch targets must be deployed at the same version level as the patch reflects. There may be exceptions to this for special things like tier-2 enabling patches, but the README files will clearly state this.
Other prerequisite patches must be applied. In the README file, there is a section that specifically deals with this. All the prerequisite conditions must be met before a patch can be successfully deployed.

At times, certain patches that are released by software vendors may adversely affect some third party software products. Thus, it would be advantageous for organizations with many users, to indicate to their users the avoidance of installing software patches until the patch has been thoroughly evaluated by the organization's information technology group or equivalent.

### SUMMARY OF THE INVENTION

The present invention provides a method, apparatus and computer instructions for blocking the installation of a patch. The exemplary aspects of the present invention utilize a patch management system that recognizes files with a selected indicator. A selected indicator may be an identifier distinguishing the file such as size, checksum, name, or a current timestamp. Files with a selected indicator contain signatures that may be cross referenced with patch metadata. The present invention validates the signature of the patch file to policies that indicate the patch has been approved for installation. If the patch is approved the files are installed. Additionally, the present invention makes use of a locking mechanism that locks files targeted by patches so that the patch may not be installed in response to a patch not being approved for installation. In one preferred embodiment the files targeted by patches are determined based on patch metadata, patch content, and/or patch instructions.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system in which the present invention may be implemented;

FIG. 4 is a block diagram of a data processing system where a patch installation is processed for installation approval;

FIG. 5 represents a flow diagram illustrating an exemplary operation of blocking the installation of a patch at a client; and

FIG. 6 represents a flow diagram illustrating an exemplary operation of the patch validation process.

### DETAILED DESCRIPTION OF THE PREFERRED EMBODIMENT

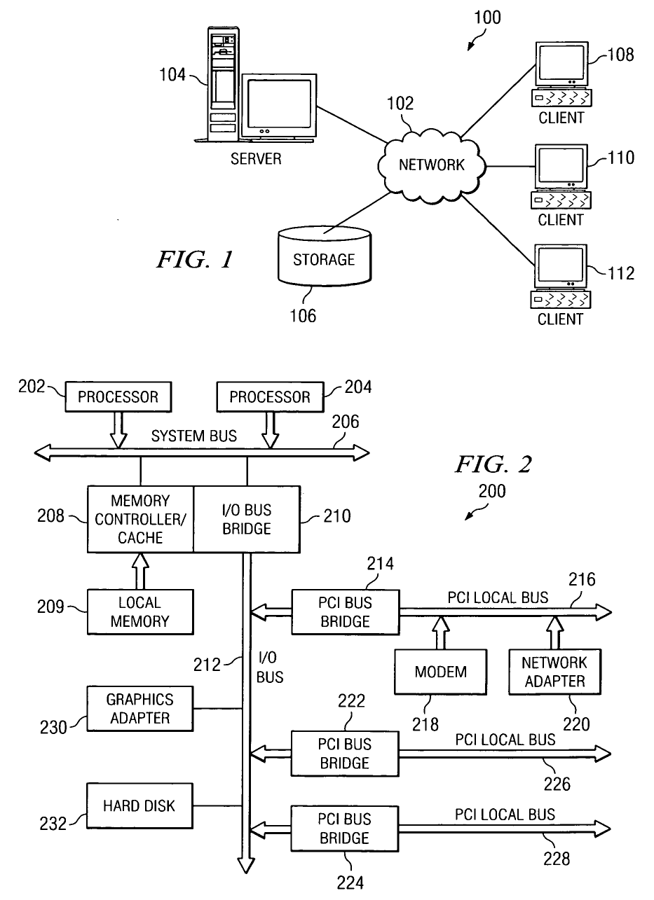

The present invention provides a method, apparatus and computer instructions for blocking the installation of a patch file. The data processing device may be a stand-alone computing device or may be a distributed data processing system in which multiple computing devices are utilized to perform various aspects of the present invention. Therefore, the following FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In accordance with a preferred embodiment of the present invention, server 104 provides application integration tools to application developers for applications that are used on clients 108, 110, 112. More particularly, server 104 may provide access to application integration tools that will allow two different front-end applications in two different formats to disseminate messages sent from each other.

In accordance with one preferred embodiment, a dynamic framework is provided for using a graphical user interface (GUI) for configuring business system management software. This framework involves the development of user interface (UI) components for business elements in the configuration of the business system management software, which may exist on storage 106. This framework may be provided through an editor mechanism on server 104 in the depicted example. The UI components and business elements may be accessed, for example, using a browser client application on one of clients 108, 110, 112.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX™) operating system or LINUX operating system.

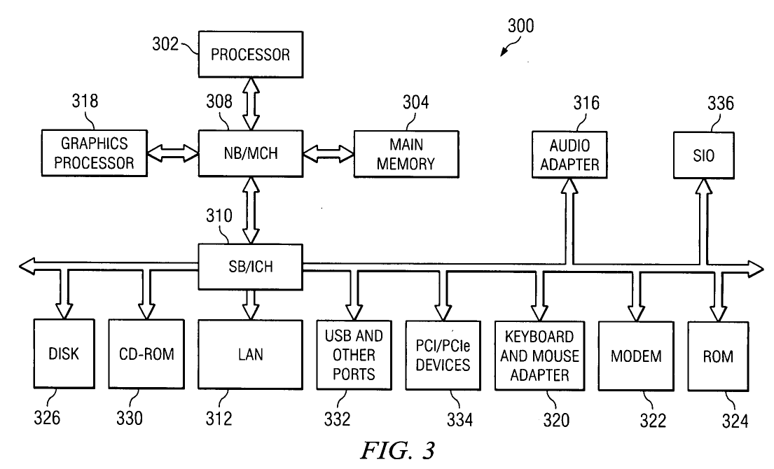

With reference now to FIG. 3, a block diagram of a data processing system is shown in which the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows Xp™, which is available from Microsoft Corporation. An object oriented programming system, such as the Java™ programming system, may run in conjunction with the operating system and provides calls to the operating system from Java™ programs or applications executing on data processing system 300. “JAVA” is a trademark of Sun Microsystems, Inc.

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

The present invention provides a method, apparatus and computer instructions for blocking the installation of a patch. The present invention utilizes a patch management system that recognizes files with a selected indicator. A selected indicator may be an identifier distinguishing the file such as size, checksum, name, or a current timestamp. A file with a current timestamp is a file that has its time/date stamp updated to a current time. Files with a selected indicator contain signatures that may be cross referenced with patch metadata. The signature of the patch file is used to identify the patch and to validate the patch against policies that indicate the patch has been approved for installation. If the patch is approved, the files are installed. If the patch is unapproved for installation, a locking mechanism is utilized that locks files targeted by patches so that the patch may not be installed.

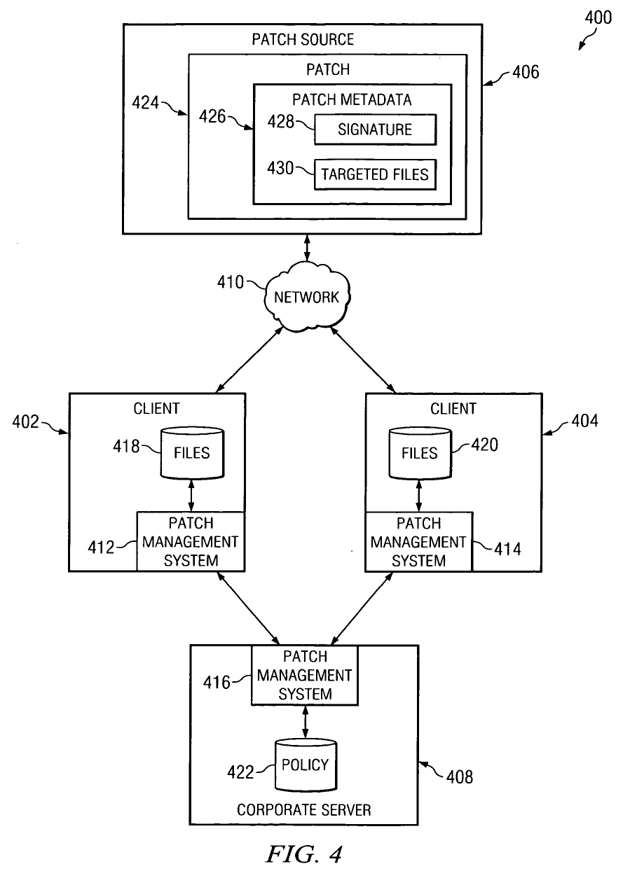

With reference now to FIG. 4, block diagram of data processing system 400 is shown in which the installation of a patch file is blocked in accordance with a preferred embodiment of the present invention. Clients 402 and 404, which correspond to clients 108, 110 and 112 of FIG. 1, include client patch management systems 412 and 414 and file databases 418 and 420. Corporate server 408 includes corporate patch management system 416 and policy database 422. As the user of client 402 experiences a software problem or symptom, the user may contact the software vendor or patch source 406, which corresponds to server 104 of FIG. 1, in order to address the encountered problem. In an exemplary embodiment of the present invention, the user makes use of an internet connection to contact patch source 406 from client 402 through network 410, which corresponds to network 102 of FIG. 1. If patch source 406 has patch 424 that addresses the software problems encountered at client 402, the user downloads patch 424 from patch source 406 through network 410 to client 402.

The user then attempts to install patch 424 provided from patch source 406 to client 402. As a preferred embodiment of the present invention, the installation of patch 424 is interrupted by client patch management system 412, which recognizes the attempt to install patch 424. Patch management system interruption or interception may be performed by an operating system, computer registry or a third party application patch mechanism. An exemplary patch management system would be a file monitoring engine, such as Tripwire® or Norton AntiVirus™. Client patch management system 412 interrupts the installation of patch 424 and reads patch metadata 426 for a signature 428 and files targeted by the patch 430. Although patch metadata 426 is shown to a part of patch 424, patch metadata 426 need not be encompassed with patch 424 and may be accessed separately from patch 424. In an alternate embodiment, if the files are targeted by the patch is not provided by patch 424, patch 424 could be parsed to see which file(s) patch 424 would be applied to. Signature 428 of patch 424 is sent to corporate patch management system 416 of corporate server 408. Corporate patch management software 416 queries policy database 422 for a policy that applies to patch 424 identified by signature 428 of patch 424.

If a policy exists within policy database 422 that validates that signature 428 of patch 424 is valid and thereby indicating that patch 424 may be installed, a response is returned from corporate patch management system 416 to client patch management system 412 indicating patch 424 should be allowed to install and the targeted files within file database 418 are updated. If a policy that validates signature 428 of patch 424 within policy database 422 does not exist, a response is sent from corporate patch management system 416 to client patch management system 412 indicating that the files within file database 418 targeted by the patch should be locked. One exemplary means of locking the targeted files may be changing the write protection of the files, though many other means are available.

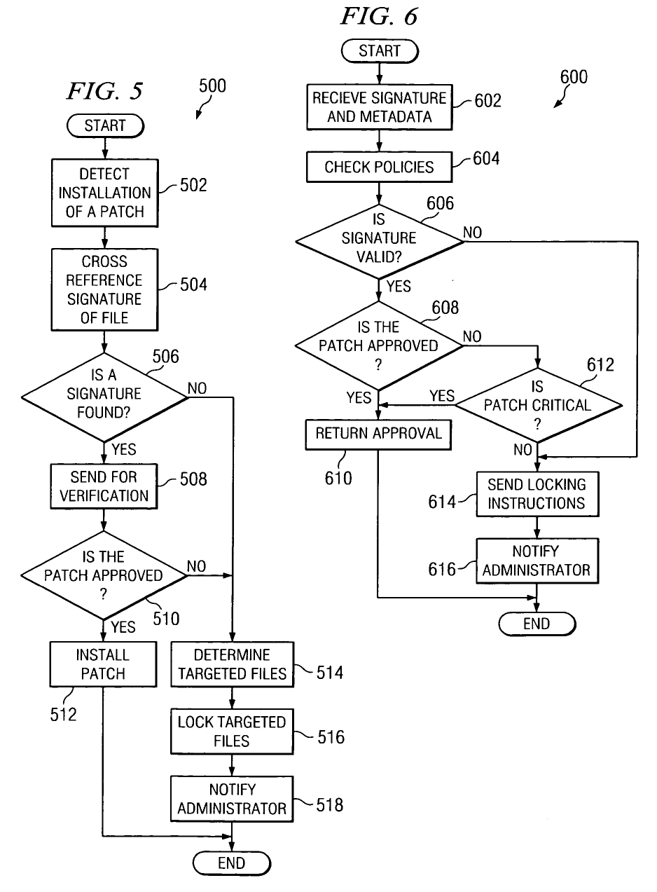

Turning now to FIG. 5, a flow diagram 500 illustrating an exemplary operation in which the installation of a patch files is either approved or blocked in accordance with a preferred embodiment of the present invention. As the operation begins, client patch management system 412 of FIG. 4 detects the installation of a patch within a client and interrupts the installation (block 502). The patch metadata or software registry, such as patch metadata 426 of FIG. 4, may contain a signature, a list of targeted files, and the criticality of the patch, which are cross referenced by the patch management system (block 504). The client patch management system determines if a signature is found within the patch metadata or software registry (block 506). If a signature is found, it is sent along with the patch metadata to the corporate patch management system, corresponding to patch management system 416 of FIG. 4, for validation (block 508). If the patch is approved by the corporate patch management system (block 510), the installation of the patch is resumed (block 512) and the operation ends.

Returning to block 510, if the patch is unapproved by the corporate patch management system, the client patch management system determines the files targeted by the patch (block 514). In the preferred embodiment, these files are determined through patch metadata or software registry contained within the patch. Then the patch installation is terminated and the targeted files are locked so that any subsequent execution of the patch will not install (block 516). Finally, the administrator of the managed system is notified (block 518) and the operation ends.

Returning to block 506, if there is no signature found within the patch by the corporate patch management system, the client patch management system determines the files targeted by the patch (block 514). These files are determined through patch metadata or software registry contained within the patch. In an alternate embodiment, the patch could be parsed to see which file the patch would be applied to. Then, the patch installation is terminated and the targeted files are locked so that any subsequent execution of the patch will not install (block 516). Finally, the administrator of the managed system is notified of the patch installation attempt (block 518) and the operation ends.

In FIG. 6, a flow diagram 600 illustrating an exemplary operation of the patch validation process in accordance with a preferred embodiment of the present invention. As the operation begins, a signature is received from a client patch management system (block 602) and a policy database is queried (block 604). A first determination is made as to whether the signature is a valid signature (block 606). Determination as to the validity of a patch is a two step process. Manufacturers of patches provide a signature that may be used on many different patches. Validation of a signature as a trusted manufacturer is only the first step. The first step is made by comparing the signature of the patch to signature of trusted manufacturers. The second step is comparing the patch related to the manufacturer to those patches that have already been reviewed, tested, and approved by an administrator of the client patch management system. Only after an administrator has reviewed the patch and its intended resolution, does the administrator deem the patch as safe and add the patch to the policy database. Thus, if the signature is valid, then a determination is made as to whether the patch has been approved for installation (block 608). If the patch has been approved, then the corporate patch management system sends a response to the client patch management system indicating patch approval (block 610) with the operation ending thereafter.

Returning to block 606, if the provided signature is not valid, then locking instructions are set to the client patch management system indicating that the targeted files should be locked (block 614). Although redundant, the administrator of the managed system is notified of the patch installation attempt (block 616) and the operation ends. Returning to block 608, if the patch has not been approved, a determination of the criticality of the patch is performed. If the criticality of the patch is high (block 612), then the corporate patch management system sends a response to the client patch management system indicating patch approval (block 610) with the operation ending thereafter. If the criticality of the patch is low (block 612), then locking instructions are set to the client patch management system indicating that the targeted files should be locked (block 614). Although redundant, the administrator of the managed system is notified of the patch installation attempt (block 616) and the operation ends.

In summary, the present invention provides a method, apparatus and computer instructions for blocking the installation of a patch file. A patch management system recognizes files with a selected indicator that are attempting to be installed. A selected indicator may be an identifier distinguishing the file such as size, checksum, name, or a current timestamp. The files with a selected indicator contain signatures that may be cross referenced with patch metadata. The signature of the patch file is validated against existing policies that indicate the patch has been approved for installation. If the patch is approved the files are installed. If the patch is unapproved for installation a locking mechanism locks files targeted by patches so that the patch may not be installed. The files targeted by patches are determined based on patch metadata, patch content and/or patch instructions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for blocking the installation of a patch, the method comprising:
determining an attempt to install a patch;
interrupting the attempt to install;
determining if the patch is approved for installation;
in response to the patch being approved, continuing with the installation of the patch; and
in response to the patch being unapproved, selectively locking the files targeted by the patch.

2. The method of claim 1, wherein the step of selectively locking the files targeted by the patch comprises:
verifying the criticality of the patch based on metadata associated with the patch;
in response to the criticality of the patch being above a predetermined level, continuing with the installation of the patch; and
in response to the criticality of the patch being below the predetermined level, locking the files targeted by the patch.

3. The method of claim 1, wherein the determining if the patch is approved for installation comprises:
determining a signature that is included with the patch; and
validating the signature.

4. The method of claim 3, further comprising:
determining metadata associated with the patch; and
validating the patch has been previously tested using the metadata.

5. The method of claim 1, further comprising:
notifying an administrator of the unapproved installation attempt.

6. The method of claim 1, wherein the determining if the patch is approved for installation comprises:
sending a signature and metadata associated with the patch from a client to a validation server;
validating the signature against a policy database; and
responding to the client from the validation server.

7. The method of claim 6, further comprising:
validating the metadata against the policy database; and
responding to the client from the validation server.

8. The method of claim 1, further comprising:
providing a policy database for patch installation; and
wherein the step of determining if the patch is approved for installation is carried out by reference to the policy database.

9. A data processing system comprising:
a bus system;
a communications system connected to the bus system;
a memory connected to the bus system, wherein the memory includes a set of instructions; and
a processing unit connected to the bus system, wherein the processing unit executes the set of instructions to determine an attempt to install a patch; interrupt the attempt to install; determine if the patch is approved for installation; continue with the installation of the patch in response to the patch being approved; and selectively lock the files targeted by the patch in response to the patch being unapproved.

10. The data processing system of claim 9, wherein the set of instructions to selectively lock the files targeted by the patch comprises:
a set of instruction to verify the criticality of the patch based on metadata associated with the patch; continuing with the installation of the patch in response to the criticality of the patch being above a predetermined level; and lock the files targeted by the patch in response to the criticality of the patch being below the predetermined level.

11. The data processing system of claim 9, wherein the instructions to determine if the patch is approved for installation comprises:
a set of instructions to determine a signature that is included with the patch; validate the signature, determine metadata associated with the patch; and validate the patch has been previously tested using the metadata.

12. The data processing system of claim 9, wherein the instructions to determine if the patch is approved for installation comprises:
a set of instruction to send a signature and metadata associated with the patch from a client to a validation server; validate the signature against a policy database; and respond to the client from the validation server.

13. The data processing system of claim 12, further comprising:
a set of instructions to validate the metadata against the policy database; and respond to the client from the validation server.

14. The data processing system of claim 9, further comprising:
a set of instructions to provide a policy database for patch installation; and
wherein the step of determining if the patch is approved for installation is carried out by reference to the policy database.

15. A computer program product comprising:
a computer usable medium including computer usable program code for blocking the installation of a patch, the computer program product including;
computer usable program code for determining an attempt to install a patch;
computer usable program code for interrupting the attempt to install;
computer usable program code for determining if the patch is approved for installation;
computer usable program code for continuing with the installation of the patch in response to the patch being approved; and
computer usable program code for selectively locking the files targeted by the patch in response to the patch being unapproved.

16. The computer program product of claim 15, wherein the computer usable program code for selectively locking the files targeted by the patch comprises:
computer usable program code for verifying the criticality of the patch based on metadata associated with the patch;
computer usable program code for continuing with the installation of the patch in response to the criticality of the patch being above a predetermined level; and
computer usable program code for locking the files targeted by the patch in response to the criticality of the patch being below the predetermined level.

17. The computer program product of claim 15, wherein the computer usable program code for determining if the patch is approved for installation comprises:
computer usable program code for determining a signature that is included with the patch; and
computer usable program code for validating the signature.
computer usable program code for determining metadata associated with the patch; and
computer usable program code for validating the patch has been previously tested using the metadata.

18. The computer program product of claim 15, wherein the computer usable program code for determining if the patch is approved for installation comprises:
computer usable program code for sending a signature and metadata associated with the patch from a client to a validation server;
computer usable program code for validating the signature against a policy database; and
computer usable program code for responding to the client from the validation server.

19. The computer program product of claim 6, further comprising:
computer usable program code for validating the metadata against the policy database; and
computer usable program code for responding to the client from the validation server.

20. The computer program product of claim 15, further comprising:
computer usable program code for providing a policy database for patch installation; and
wherein the step of determining if the patch is approved for installation is carried out by reference to the policy database.
